(19) United States
(12) Patent Application Publication
(10) Pub. No.: US 2012/0275456 A1
(43) Pub. Date: Nov. 1, 2012

(54) EXPEDITED GRACEFUL OSPF RESTART

(76) Inventor: Amarnath Ammireddy, Santa Clara, CA (US)

(21) Appl. No.: 13/096,642

(22) Filed: Apr. 28, 2011

(51) Int. Cl. H04L 12/56

(52) U.S. Cl. 370/390; 370/400

(57) ABSTRACT

A first network element attempts to expedite a Graceful OSPF (Open Shortest Path First) Restart procedure in a second network element. The first network element receives a message from the second network element that indicates an intention of the second network element to perform a Graceful OSPF Restart procedure. The second network element is a neighbor of the first network element. Responsive to receiving the message, the first network element transmits a unicast Hello packet to that second network element irrespective of an OSPF Hello interval of the first network element in an attempt to cause the second network element to move to an OSPF 2-way neighbor state with the first network element and trigger an OSPF database description exchange procedure of the Graceful OSPF Restart procedure between the first network element and the second network element.

### FIELD

Embodiments of the invention relate to the field of networking; and more specifically, to expedited Graceful OSPF (Open Shortest Path First) Restart.

### BACKGROUND

A network element (e.g., a router, a switch, a bridge) is a piece of networking equipment, including hardware and software, that communicatively interconnects other equipment on the network (e.g., other network elements, end stations). Network elements are commonly separated into a control plane and a data plane (sometimes referred to as a forwarding plane or a media plane). In the case that the network element is a router (or is implementing routing functionality), the control plane typically determines how data (e.g., packets) is to be routed (e.g., the next hop for the data and the outgoing port for that data), and the data plane is in charge of forwarding that data. For example, the control plane typically includes one or more routing protocols (e.g., OSPF defined in RFC (Request for Comments) 2328, April 1998), that communicate with other network elements to exchange routes and select those routes based on one or more routing metrics. Routes and adjacencies are stored in one or more routing structures (e.g., Routing Information Base (RIB), Link State Database (LSDB), Label Information Base (LIB), one or more adjacency structures) on the control plane. The control plane programs the data plane with information (e.g., adjacency and route information) based on the routing structure(s). For example, the control plane programs the adjacency and route information into one or more forwarding structures (e.g., Forwarding Information Base (FIB), Label Forwarding Information Base (LFIB), and one or more adjacency structures) on the data plane. The data plane uses these forwarding and adjacency structures when forwarding traffic.

Typically, a network element includes a set of one or more line cards, a set of one or more control cards, and optionally a set of one or more service cards (sometimes referred to as resource cards). These cards are coupled together through one or more mechanisms (e.g., a first full mesh coupling the line cards and a second full mesh coupling all of the cards). The set of line cards make up the data plane, while the set of control cards provide the control plane and exchange packets with external network element through the line cards. The set of service cards can provide specialized processing (e.g., Layer 4 to Layer 7 services (e.g., firewall, IPsec, IDS, P2P), VoIP Session Border Controller, Mobile Wireless Gateways (GGSN, Evolved Packet System (EPS) Gateway)). By way of example, a service card may be used to terminate IPsec tunnels and execute the attendant authentication and encryption algorithms.

A Graceful Restart procedure has been defined for the OSPF protocol (defined in RFC 3623, November 2003) to accomplish hitless forwarding while the OSPF control software is restarted and/or reloaded. Graceful Restart attempts to maintain the forwarding capability while the control software is restarted and/or related. During the Graceful Restart procedure, the OSPF control software relearns the network topology with the OSPF neighbors' help. Relearning the network topology requires the restarting network element and its helping neighbors perform an OSPF database description exchange procedure (an exchange of database description packets, which is described in RFC 2328) to synchronize databases. The OSPF protocol defines a neighbor state machine that includes several neighbor states including a 2-way state. The database description exchange procedure cannot be performed until the restarting network element is in the 2-way state with the helping neighbor network element. A 2-way state indicates bidirectional communication between the restarting network element and the helping neighbor network element. The restarting network element will move to 2-way state with a helping neighbor network element upon receiving a Hello packet from the helping neighbor network element that includes an identifier of itself. Each network element periodically multicasts a Hello packet according to an OSPF Hello interval that indicates the amount of time (e.g., the number of seconds) between transmitting Hello packets. At the end of the Graceful Restart procedure (assuming that the procedure is successful), the restarted network element is ready to react to any new network changes.

The amount of time it takes for the Graceful Restart procedure to complete successfully depends on various factors (e.g., the size of the link state database (LSDB)). If there is a change in the network topology during the Graceful Restart procedure, the Graceful Restart procedure exits unsuccessfully and hitless forwarding cannot be performed. Thus, for hitless forwarding to be accomplished and the network element to be able to react to network changes, the Graceful Restart procedure needs to complete as early as possible following a restart.

In existing Graceful Restart procedure implementations, following a network element restarting, it may take up to one Hello interval period before the OSPF database description exchange procedure is started during the Graceful Restart procedure. This may lead to a longer period of time before the restarting network element is ready to react to network topology changes.

### SUMMARY

A first network element attempts to expedite a Graceful OSPF Restart procedure in a second network element. The first network element receives a message from the second network element that indicates an intention of the second network element to perform a Graceful OSPF Restart procedure. The second network element is a neighbor of the first network element. Responsive to receiving the message, the first network element transmits a unicast Hello packet to the second network element irrespective of an OSPF Hello interval of the first network element in an attempt to cause the second network element to move to an OSPF 2-way neighbor state with the first network element and trigger an OSPF database description exchange procedure of the Graceful OSPF Restart procedure between the first network element and the second network element.

In one embodiment, a first network element is configured to attempt to expedite a Graceful OSPF Restart procedure in a second network element. The first network element includes an interface configured to receive a message from the second network element that indicates an intention of the second network element to perform a Graceful OSPF Restart procedure. The second network element is a neighbor of the first network element. The first network element further includes an OSPF module coupled with the interface that is configured to periodically cause a Hello packet to be transmitted out the interface according to an OSPF Hello interval and is further configured to, in response to receipt of the message, cause a unicast Hello packet to be transmitted out the interface towards the second network element irrespective of the OSPF Hello interval in an attempt to cause the second network element to move to an OSPF 2-way neighbor state with the first network element and trigger an OSPF database description exchange procedure of the Graceful OSPF Restart procedure between the first network element and the second network element.

In one embodiment, a system for expediting a Graceful OSPF Restart procedure includes a first network element a first network element configured to receive a message from a second network element that indicates an intention of the second network element to perform a Graceful OSPF Restart procedure. Responsive to receipt of that message, the first network element is configured to transmit a unicast Hello packet to the second network element irrespective of an OSPF Hello interval of the first network element in an attempt to cause the second network element to move to an OSPF 2-way neighbor state with the first network element and trigger an OSPF database description exchange procedure of the Graceful OSPF Restart procedure between the first network element and the second network element. The second network element is configured to receive the unicast Hello packet, and responsive to receipt of that unicast Hello packet, move to the OSPF 2-way neighbor state with the first network element and begin the OSPF database description exchange procedure with the first network element.

Embodiments of the invention described herein drive the restarting network element to a 2-way neighbor state with its helping network element(s) irrespective of an OSPF Hello interval thereby expediting the Graceful OSPF Restart procedure.

### BRIEF DESCRIPTION OF THE DRAWINGS

The invention may best be understood by referring to the following description and accompanying drawings that are used to illustrate embodiments of the invention. In the drawings:

FIG. 1 illustrates an exemplary expedited Graceful OSPF Restart procedure according to one embodiment;

FIG. 2 is a flow diagram illustrating exemplary operations performed by a restarting network element according to one embodiment;

FIG. 3 is a flow diagram illustrating exemplary operations performed by a helping network element according to one embodiment;

FIG. 4 illustrates an exemplary architecture of a restarting network element according to one embodiment;

FIG. 5 illustrates an exemplary architecture of a helping network element according to one embodiment; and

FIG. 6 illustrates an exemplary network element used in some embodiments of the invention.

### DESCRIPTION OF EMBODIMENTS

In the following description, numerous specific details are set forth. However, it is understood that embodiments of the invention may be practiced without these specific details. In other instances, well-known circuits, structures and techniques have not been shown in detail in order not to obscure the understanding of this description. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

A method and apparatus for expediting Graceful OSPF Restart is described. In one embodiment of the invention, upon an OSPF neighbor network element receiving a message from a network element that indicates an intention of that network element to perform a Graceful OSPF Restart procedure (e.g., upon receiving a Grace-LSA (Link State Advertisement)), after processing that message, it transmits a unicast Hello packet on the network interface on which the message was received. The unicast Hello packet is transmitted irrespective of the OSPF Hello interval. The unicast Hello packet is transmitted in an attempt to move the restarting network element to a 2-way neighbor state and trigger the OSPF database description exchange procedure to expedite the Graceful OSPF Restart procedure. In one embodiment, the unicast Hello packet is transmitted substantially immediately after processing the message.

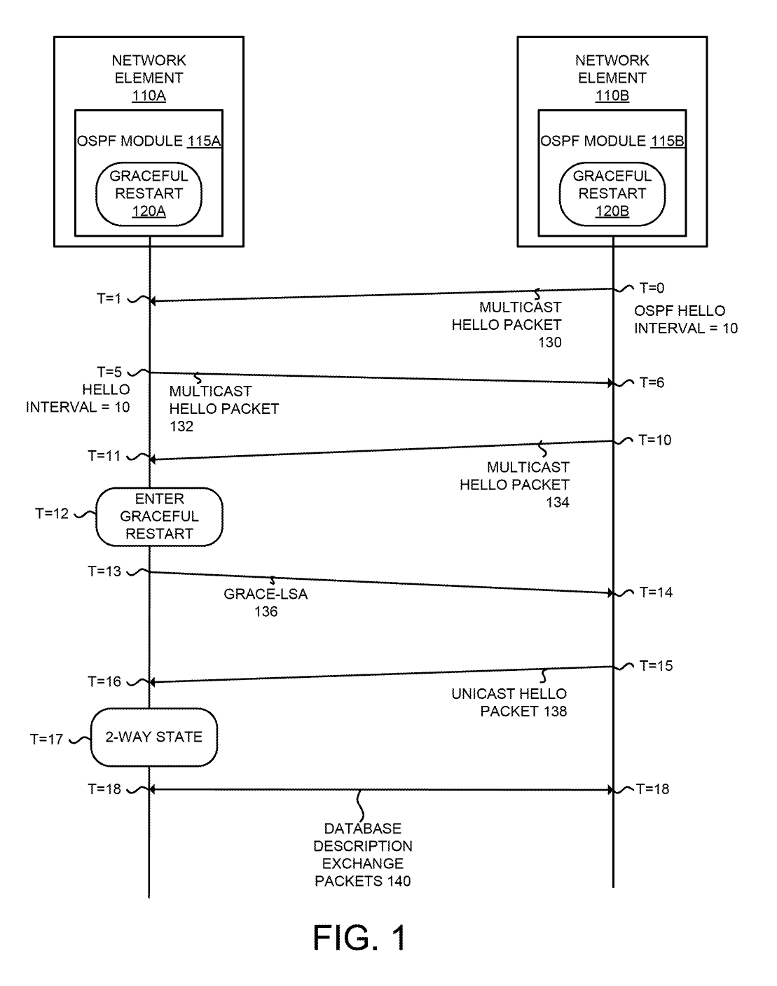

FIG. 1 illustrates an exemplary expedited Graceful OSPF Restart procedure according to one embodiment. FIG. 1 includes the network elements 110A and 110B. The network elements 110A-B include the OSPF modules 115A-B and Graceful Restart modules 120A-B respectively. Assume for the purposes of FIG. 1, that the network element 110A will be performing the Graceful OSPF Restart procedure.

During normal operation, the network elements 110A-B periodically multicast OSPF Hello packets according to an OSPF Hello interval (the OSPF Hello interval is typically the same between network elements in a network, but may be staggered to reduce traffic congestion). At a time 0, the network element 110B multicasts the OSPF Hello packet 130, which is received at the network element 110A at a time 1. Although FIG. 1 illustrates a single network element receiving the OSPF Hello packet 130, it should be understood that there may be (and typically is) multiple network elements that will receive the OSPF Hello packet 130. For exemplary purposes, the OSPF Hello interval is a time of 10 for the network element 110B. At a time 5, the network element 110A multicasts the OSPF Hello packet 132, which is received at the network element 110B at a time 2. For exemplary purposes, the OSPF Hello interval is a time of 10 for the network element 110A, although it is staggered as compared with the network element 110B. At a time 10 (since the OSPF Hello interval for the network element has expired), the network element 110B multicasts the OSPF Hello packet 134, which is received at the network element 110A at a time 11.

At a time 12, the network element 110A enters graceful OSPF restart mode. In one embodiment and for the purposes of the following explanation, the network element 110A enters graceful OSPF restart mode due to an unplanned outage (e.g., the control plane software has crashed, an unexpected switchover to a redundant control card has occurred, etc.). During the graceful OSPF restart mode, the restarting network element (the network element 110A) originates a grace-LSA for each of its OSPF interfaces. Because of the unplanned outage, the network element 110A is not aware of its previous neighbor relationship with the network element 110B (or other network elements). As a result, the network element 110A multicasts the grace-LSA 136 at a time 13, which is received by the network element 110B at a time 14.

The grace-LSA 136 indicates an intention of the network element 110A to perform the graceful OSPF restart procedure. The format of the grace-LSA 136 is defined in the RFC 3623. Among other things, the grace-LSA includes a requested grace period during which its neighbors continue to announce the restarting network element (the network element 110A) in their LSAs as if it were fully adjacent (OSPF neighbor state Full) if the network topology remains static.

The network element 110B receives the grace-LSA 136 at a time 14. Substantially soon after processing the grace-LSA 136, the network element 110B originates and transmits a unicast Hello packet 138 to the network element 110A at a time 15. The unicast Hello packet 138 is sent on the network interface in which the grace-LSA 136 was received and thus will drive the network element 110A to be in a 2-way neighbor state with the network element 110B when the unicast Hello packet 138 is received. In one embodiment, processing the grace-LSA 136 includes marking the network element 110A as being in Graceful OSPF Restart mode and starting a timer based on the requested grace period in the grace-LSA 136 such that the network element 110B will continue to announce the network element 110A in its LSAs as if it were fully adjacent (as long as the network topology remains static). Thus, after receiving and processing the grace-LSA 136, the network element 110B moves to Graceful Restart Helper mode for the network element 110A. The Graceful Restart Helper mode is described in RFC 3623.

As previously described, as part of the Graceful Restart procedure, the OSPF control software on the restarting network element relearns the network topology with its OSPF neighbors' help. Relearning the network topology requires the restarting network element and its helping neighbors perform an OSPF database description exchange procedure to synchronize databases. The database description exchange procedure between the restarting network element and a helping network element cannot be performed until the restarting network element is in a 2-way neighbor state with the helping network element. A 2-way neighbor state indicates bidirectional communication. The restarting network element will move to a 2-way neighbor state with a helping neighbor network element upon receiving a Hello packet from that helping neighbor network element that includes an identifier of the restarting network element.

Therefore, even though the network element 110B multicasted the Hello packet 134 at a time 10 and is not due to transmit the next multicast Hello packet until a time 20 (the OSPF Hello interval is 10), the network element 110B transmits the unicast Hello packet 138 at a time 15 irrespective of the OSPF Hello interval in an attempt to move the network element 110A to a 2-way neighbor state as fast as possible in order to trigger the database description exchange procedure and expedite the Graceful OSPF Restart procedure. With reference back to FIG. 1, at a time 16 the network element 110A receives the unicast Hello packet 138 from the network element 110B. At a time 17, the network element 110A moves to a 2-way neighbor state with the network element 110B. At a time 18, the network elements 110A and 110B begin the database description exchange procedure to exchange the database description exchange packets 140.

It should be understood that if the network element 110B did not transmit the unicast Hello packet 138 at the time 15 and instead waited for its OSPF Hello interval to expire (at a time 20) to transmit a Hello packet to the network element 110B, the network element 110A will be delayed from moving to a 2-way neighbor state with the network element 110B thereby causing the start of the graceful restart procedure also to be delayed. Thus, embodiments of the invention described herein drive the restarting network element to a 2-way neighbor state with its helping network element(s) irrespective of an OSPF Hello interval thereby expediting the Graceful OSPF Restart procedure.

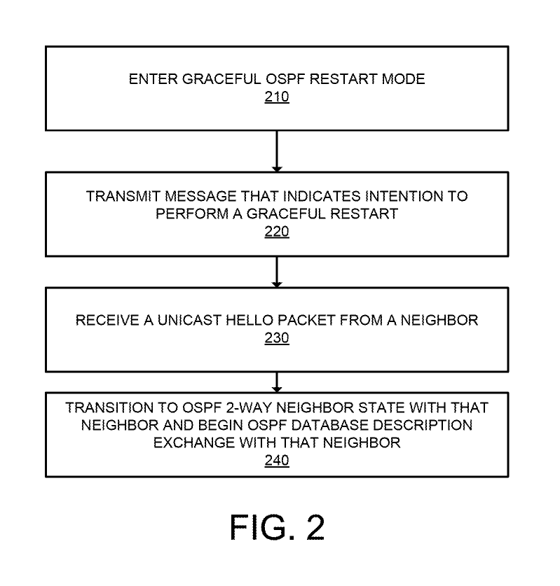

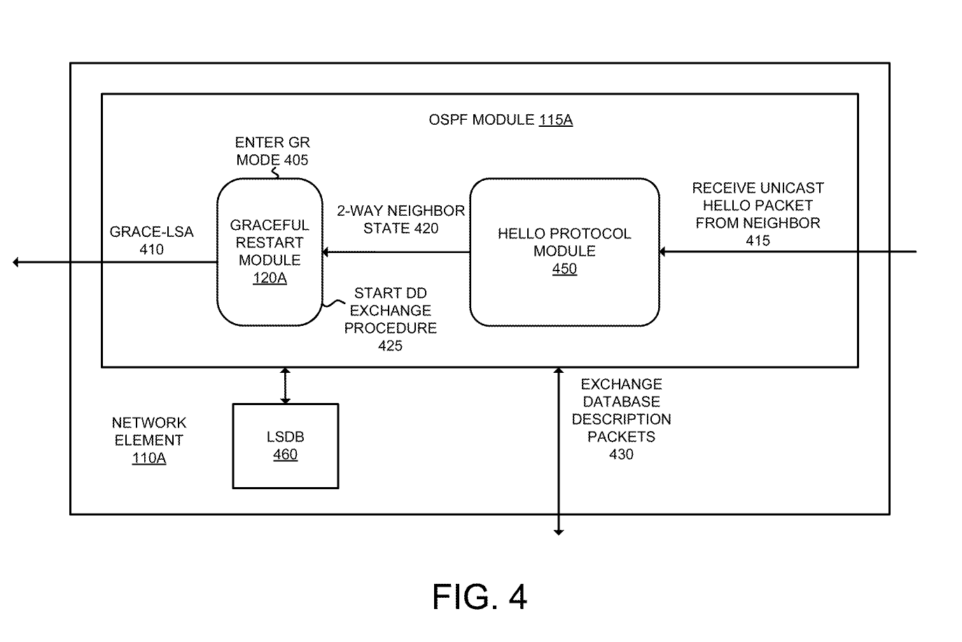

FIG. 2 is a flow diagram illustrating exemplary operations performed by a restarting network element according to one embodiment. The operations of FIG. 2 will be described with reference to the exemplary embodiment of FIG. 4, which illustrates an exemplary architecture of a restarting network element according to one embodiment. However, it should be understood that the operations of FIG. 2 can be performed by embodiments other than those discussed with reference to FIG. 4, and the embodiments discussed with reference to FIG. 4 can perform operations different than those discussed with reference to FIG. 2.

At operation 210, the network element 110A enters Graceful OSPF Restart mode. For purposes of the following description, the network element 110A enters Graceful OSPF Restart mode due to an unplanned outage (e.g., the control plane software has crashed, an unexpected switchover to a redundant control card has occurred, etc.). For example, with reference to FIG. 4, the OSPF module 115A may have been reset or control has unexpectedly been given to a redundant control card in the network element 110A. The Graceful Restart module 120A of the OSPF module 115A enters Graceful OSPF Restart mode at operation 405.

Flow then moves to operation 220 and the network element 110A transmits a message that indicates its intention to perform a Graceful OSPF Restart procedure. With respect to FIG. 4, the Graceful Restart module 120A transmits a grace-LSA at operation 410 to indicate its intention to perform a Graceful OSPF Restart procedure. Since the network element 110A is not aware of its previous neighbor relationships (due to the unplanned outage), the Graceful Restart module 120A multicasts the grace-LSA.

Flow moves from operation 220 to operation 230 where the network element 110A receives a unicast Hello packet from a neighboring network element. For example, the Hello protocol module 450 receives a unicast Hello packet from a neighboring network element at operation 415.

Flow moves from operation 230 to operation 240 where the network element 110A transitions to an OSPF 2-way neighbor state with the neighboring network element it received the unicast Hello packet from and begins the OSPF database description exchange procedure with that neighboring network element. With reference to FIG. 4, the Hello packet received by the Hello protocol module 450 causes a transition to OSPF 2-way neighbor state at operation 420 which triggers the database description exchange procedure at operation 425. The database description exchange procedure includes exchanging the database description packets 430 with the helping network element in order to synchronize the LSDB 460 with the LSDB of the helping network element.

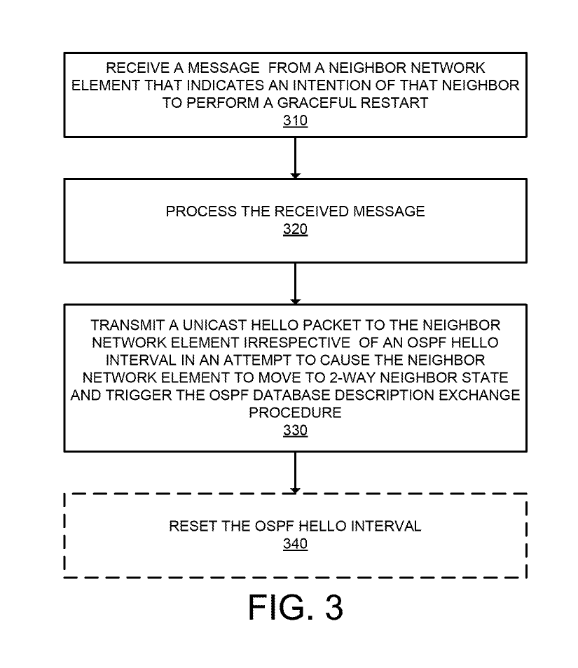

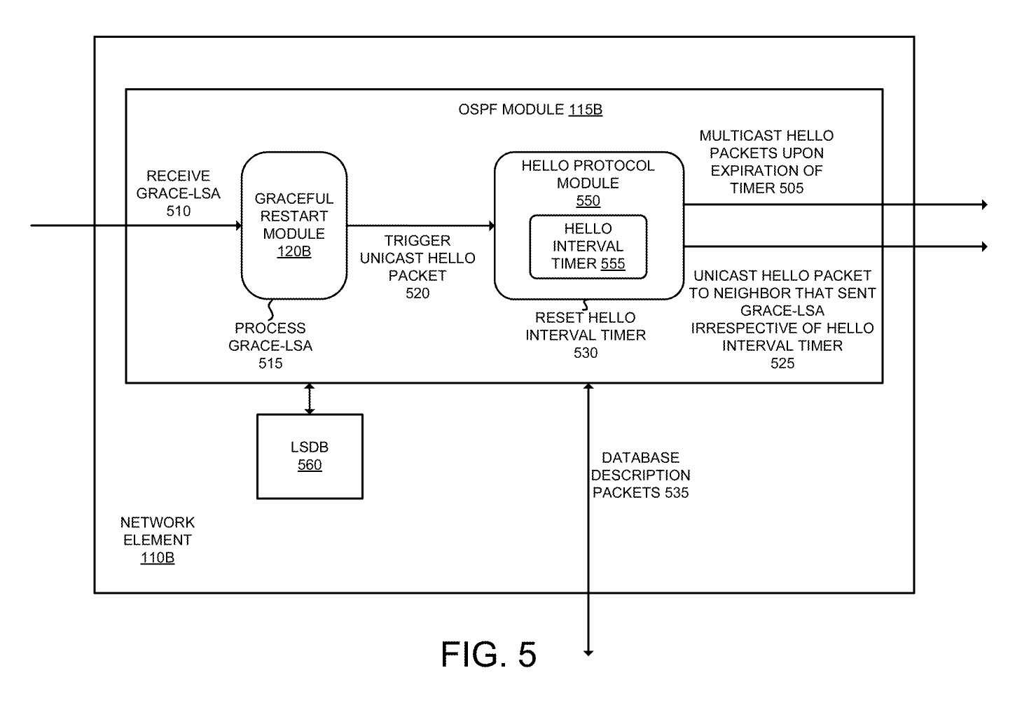

FIG. 3 is a flow diagram illustrating exemplary operations performed by a helping network element according to one embodiment. The operations of FIG. 3 will be described with reference to the exemplary embodiment of FIG. 5, which illustrates an exemplary architecture of a helping network element according to one embodiment. However, it should be understood that the operations of FIG. 3 can be performed by embodiments other than those discussed with reference to FIG. 5, and the embodiments discussed with reference to FIG. 5 can perform operations different than those discussed with reference to FIG. 3.

At operation 310, the network element 110B receives a message from a neighbor network element that indicates an intention of that neighbor to perform a graceful restart. With reference to FIG. 5, the Graceful Restart module 120B of the OSPF module 115B receives the grace-LSA that indicates an intention of the network element 110A to perform a graceful restart at operation 510.

Flow moves from operation 310 to operation 320 where the network element 110B processes the message. For example, the Graceful Restart module 120B processes the grace-LSA 515. In one embodiment, processing the grace-LSA includes marking the network element 110A as being in Graceful OSPF Restart mode and starting a timer based on the requested grace period in the grace-LSA such that it will continue to announce the network element 110A in its LSAs as if it were fully adjacent (as long as the network topology remains static). Flow moves from operation 320 to operation 330.

At operation 330, substantially immediately after processing the message, the network element 110B originates and transmits a unicast Hello packet to the neighbor network element irrespective of its OSPF Hello interval in an attempt to cause the neighbor network element to move to 2-way neighbor state and trigger the OSPF database description procedure. The unicast Hello packet is transmitted out the interface in which the grace-LSA was received. The unicast Hello packet includes information that identifies the restarting network element. With reference to FIG. 5, the grace-LSA triggers 520 the Hello protocol module 550 to generate and transmit a unicast Hello packet to the restarting network element 110A irrespective of the Hello interval timer 555. Thus, the Hello packet is transmitted without regard to the expiration of the Hello interval timer 555. Sometime after transmitting the unicast Hello packet to the restarting network element (and assuming that the restarting network element received the unicast Hello packet), the database description exchange procedure between the restarting network element and the network element 110B begins. The database description exchange procedure includes the network element 110B transmitting database description packets 535 to the restarting network element that synchronize the LSDB 560 with the LSDB of the restarting network element.

Flow moves from operation 330 to the optional operation 340 where the OSPF Hello interval is reset. With reference to FIG. 5, the Hello protocol module 550 periodically multicasts Hello packets 505 upon expiration of the Hello interval timer 555. In some embodiments, in conjunction with transmitting the unicast Hello packet to the restarting network element, the Hello protocol module 550 resets 530 the Hello interval timer 555. In other embodiments, the Hello interval timer 555 is not reset and the Hello protocol module 550 multicasts Hello packets upon expiration of the Hello interval as normal (thus the transmission of the unicast Hello packet does not affect the transmission of the multicast Hello packets).

Thus, embodiments of the invention described herein drive the restarting network element to a 2-way neighbor state with its helping network element(s) irrespective of an OSPF Hello interval thereby expediting the Graceful OSPF Restart procedure.

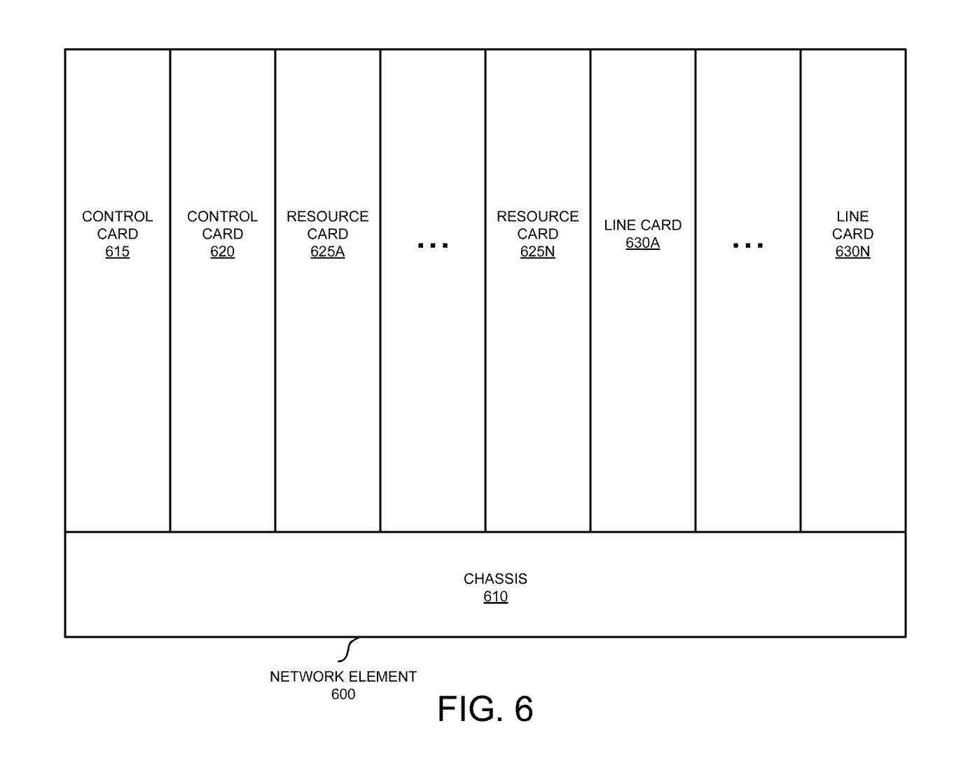

FIG. 6 illustrates an exemplary network element used in some embodiments of the invention. As illustrated in FIG. 6, the network element 600 includes the control cards 615 and 620 (e.g., one control card is active the other is a backup), the resource cards 625A-625N, and the line cards 630A-630N. It should be understood that the architecture of the network element 600 illustrated in FIG. 6 is exemplary, and different combinations of cards may be used in other embodiments of the invention. In one embodiment, the network element 110A and/or network element 110B have an architecture similar to that as illustrated in FIG. 6.

Each of the cards illustrated in FIG. 6 include one or more processors and one or more memories. For example, the line cards 630A-630B typically include one or more packet processing units to process packets including forwarding and/or switching packets at high speed, and include one or more memories to store a forwarding information base (sometimes referred to as a routing table) and a label forwarding information base. The control cards 615 and 620 also include one or more processors to perform signaling, routing (including creation of and/or management of routing tables), connection setup, session setup, etc. For example, among other things, the control card 615 execute instructions stored in memory to execute the OSPF module 115A (including the Graceful restart module 120A). As described herein, instructions may refer to specific configurations of hardware such as application specific integrated circuits (ASICs) configured to perform certain operations or having a predetermined functionality or software instructions stored in memory embodied in a non-transitory computer readable medium. Thus, the techniques shown in the figures can be implemented using code and data stored and executed on one or more electronic devices (e.g., a network element). Such electronic devices store and communicate (internally and/or with other electronic devices over a network) code and data using computer-readable media, such as non-transitory computer-readable storage media (e.g., magnetic disks; optical disks; random access memory; read only memory; flash memory devices; phase-change memory) and transitory computer-readable communication media (e.g., electrical, optical, acoustical or other form of propagated signals—such as carrier waves, infrared signals, digital signals). In addition, such electronic devices typically include a set of one or more processors coupled to one or more other components, such as one or more storage devices (non-transitory machine-readable storage media), user input/output devices (e.g., a keyboard, a touchscreen, and/or a display), and network connections. The coupling of the set of processors and other components is typically through one or more busses and bridges (also termed as bus controllers). Thus, the storage device of a given electronic device typically stores code and/or data for execution on the set of one or more processors of that electronic device. Of course, one or more parts of an embodiment of the invention may be implemented using different combinations of software, firmware, and/or hardware.

While the flow diagrams in the figures show a particular order of operations performed by certain embodiments of the invention, it should be understood that such order is exemplary (e.g., alternative embodiments may perform the operations in a different order, combine certain operations, overlap certain operations, etc.)

While the invention has been described in terms of several embodiments, those skilled in the art will recognize that the invention is not limited to the embodiments described, can be practiced with modification and alteration within the spirit and scope of the appended claims. The description is thus to be regarded as illustrative instead of limiting.

What is claimed is:

1. A method in a first network element to attempt to expedite a Graceful OSPF (Open Shortest Path First) Restart procedure in a second network element, the method comprising the steps of:
receiving a message from the second network element that indicates an intention of the second network element to perform a Graceful OSPF Restart procedure, wherein the second network element is a neighbor of the first network element;
responsive to the step of receiving, transmitting a unicast Hello packet to that second network element irrespective of an OSPF Hello interval of the first network element in an attempt to cause the second network element to move to an OSPF 2-way neighbor state with the first network element and trigger an OSPF database description exchange procedure of the Graceful OSPF Restart procedure between the first network element and the second network element.

2. The method of claim 1, wherein the message is a Grace-LSA (link state advertisement).

3. The method of claim 1, further comprising the step of: resetting the OSPF Hello interval responsive to transmitting the unicast Hello packet.

4. The method of claim 1, further comprising the step of: upon a period of the OSPF Hello interval expiring, multicasting a Hello packet out one or more interfaces of the first network element including an interface coupled with the second network element.

5. The method of claim 1, wherein the unicast Hello packet is transmitted on an interface in which the message is received.

6. The method of claim 1, wherein the unicast Hello packet includes information that identifies the second network element.

7. The method of claim 1, further comprising the step of:
processing the received message, wherein the step of processing includes marking the second network element as being in Graceful Restart mode.

8. A first network element configured to attempt to expedite a Graceful OSPF (Open Shortest Path First) Restart procedure in a second network element, the first network element including:
an interface configured to receive a message from the second network element that indicates an intention of the second network element to perform a Graceful OSPF Restart procedure, wherein the second network element is a neighbor of the first network element; and
an OSPF module coupled with the interface, the OSPF module configured to perform the following:
periodically cause a Hello packet to be transmitted out the interface according to an OSPF Hello interval, and
in response to receipt of the message, cause a unicast Hello packet to be transmitted out the interface towards the second network element irrespective of the OSPF Hello interval in an attempt to cause the second network element to move to an OSPF 2-way neighbor state with the first network element and trigger an OSPF database description exchange procedure of the Graceful OSPF Restart procedure between the first network element and the second network element.

9. The first network element of claim 8, wherein the message is a Grace-LSA (link state advertisement).

10. The first network element of claim 8, wherein the OSPF module is further configured to, in response to the unicast Hello packet being transmitted, reset the OSPF Hello interval.

11. The first network element of claim 8, wherein the unicast Hello packet includes information that identifies the second network element.

12. The first network element of claim 8, wherein the OSPF module is further configured to mark the second network element as being in Graceful Restart mode responsive to receipt of the message.

13. A system for expediting a Graceful OSPF (Open Shortest Path First) Restart procedure, the system comprising:
a first network element configured to receive a message from a second network element that indicates an intention of the second network element to perform a Graceful OSPF Restart procedure, and responsive to receipt of that message, transmit a unicast Hello packet to the second network element irrespective of an OSPF Hello interval of the first network element in an attempt to cause the second network element to move to an OSPF 2-way neighbor state with the first network element and trigger an OSPF database description exchange procedure of the Graceful OSPF Restart procedure between the first network element and the second network element; and
the second network element configured to receive the unicast Hello packet, and responsive to receipt of that unicast Hello packet, move to the OSPF 2-way neighbor state with the first network element and begin the OSPF database description exchange procedure with the first network element.

14. The system of claim 13, wherein the message is a grace-LSA (link state advertisement).

15. The system of claim 13, wherein the first network element is further configured to reset the OSPF Hello interval responsive to the unicast Hello packet being transmitted to the second network element.

16. The system of claim 13, wherein the first network element is further configured to, upon a period of the OSPF Hello interval expiring, multicast a Hello packet out one or more interfaces of the first network element, including an interface coupled with the second network element.

17. The system of claim 13, wherein the first network element is further configured to transmit the unicast Hello packet on an interface in which the message is received.

18. The system of claim 13, wherein the unicast Hello packet includes information that identifies the second network element.

19. The system of claim 13, wherein the first network element is further configured to mark the second network element as being in Graceful Restart mode responsive to receipt of the message.
